(19) United States
(12) Patent Application Publication
(10) Pub. No.: US 2004/0156973 A1
(43) Pub. Date: Aug. 12, 2004

(54) Food product

(75) Inventor: Wayne Gerald Morley, Ipswich (GB)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/772,948

(22) Filed: Feb. 5, 2004

(30) Foreign Application Priority Data
Feb. 7, 2003 (GB) 0302842.0

(51) Int. Cl. A23D 7/00

(52) U.S. Cl. 426/601

(57) ABSTRACT

The invention provides a kit for preparing salads comprising at least one ingredient (I) which is cooked and at least one fruit, vegetable or cereal product, wherein the kit comprises; a flavoured cooking paste for cooking ingredient (I), which cooking paste comprises from 40 to 80% wt fat, based on the weight thereof, and a dressing for contacting with the at least one fruit, vegetable or cereal product, which dressing comprises from 0 to 60% wt fat based on the weight thereof. The kit provides an easy and convenient of preparing tasty, healthy salads comprising a cooked food ingredient. A method of making a salad using the kit and also the salad prepared from the kit is also provided.

### FIELD OF THE INVENTION

The present invention relates to a kit for preparing salads comprising a cooked food ingredient and at least one fruit, vegetable or cereal product. The invention also relates to a process for preparing salads and to the salads prepared by the process and/or by the use of the kit.

### BACKGROUND ART

Consumers are becoming increasingly interested in healthy eating and in particular in meals which are considered healthy (especially in terms of fat content) but which still taste good. There is also a consumer desire for healthy meals that are nutritious and tasty, yet, quick and convenient to prepare.

Salad meals are becoming increasingly popular and are no longer consumed simply as an accompaniment to a main meal. However, when salads are eaten as a main meal they still need to be nutritionally balanced and therefore the fruit, vegetables or cereal products used in the salads are generally eaten with a protein-rich source such as chicken, eggs, meat, fish or vegetable-derived protein source e.g. tofu or beans or with cooked vegetables, such as roasted vegetables, or even with bread which is cooked.

These protein-rich sources or vegetables need to, or are desired to, be cooked before being used in the salad and it is important that they are cooked in a way that provides for a well cooked, tasty, product. It is also important that the cooking method is convenient for the consumer.

The other component of the salad, the fruit, vegetables or cereal products, also need to have a good taste and texture and so are generally used in combination with a dressing. The consumer can then choose different flavours to make salads varied and more interesting.

The requirements of an easy-to-prepare, nutritious, tasty and yet healthy salad meal has been found in practice to not be so simple to provide because to achieve the aforementioned requirements, the consumer will add a significant amount of oil. Furthermore, flavourings are often added in addition to the oil used for cooking and to the salad dressing and these flavourings may themselves contain oil.

Accordingly, there is a need in the art to provide healthy, nutritious meals which are convenient to prepare but which have a good taste and texture.

In particular, there is a need to provide such salad meals which have a controlled fat content.

The present invention seeks to address one or more of the above-mentioned problems.

In particular, it seeks to provide salad meals which are healthy and nutritious but which are convenient to prepare and have a good taste and texture.

It also seeks to provide such salad meals which have a controlled fat content.

### SUMMARY OF THE INVENTION

Surprisingly, we have now found that at least one of the above-mentioned problems is addressed by a kit for making salads which kit comprises a cooking paste for cooking an ingredient and also a dressing which has a controlled level of fat for contacting with the other ingredients in the salad.

Thus, according to a first aspect of the present invention, there is provided a kit for preparing salads comprising at least one ingredient (I) which is cooked and at least one fruit, vegetable or cereal product, wherein the kit comprises;

a) a flavoured cooking paste for cooking ingredient (I), which cooking paste comprises from 40 to 80% wt fat, based on the weight thereof, and

b) a dressing for contacting with the at least one fruit, vegetable or cereal product, which dressing comprises from 0 to 60% wt fat based on the weight thereof.

It is preferred that the flavoured cooking paste comprises 45-75% wt fat. It is preferred that the dressing is an emulsion, especially, an oil-in-water emulsion. It is also preferred that the dressing comprises 10-40% wt fat.

The kit allows for the convenient and easy preparation of nutritious salads, especially salads that are intended to be eaten as a main course or a nutritionally balanced side dish.

The salads are suitable for consumers seeking healthy, yet tasty, meals as only a controlled amount of fat is added. Furthermore they have good taste and texture. Furthermore, because the cooking paste and the dressing form a kit for preparing salads, this allows the flavours of each product to be matched so that they complement or contrast with each other, thus providing tasty salad options for the consumer.

According to a second aspect of the invention, there is provided a process for preparing a salad comprising at least one ingredient which is cooked and at least one fruit, vegetable or cereal product, the process comprising the steps of 1) cooking the at least one ingredient in a flavoured cooking paste comprising from 40 to 80% wt fat thereof, to produce at least one cooked ingredient (I), and 2) contacting the at least one fruit, vegetable or cereal product with a dressing comprising from 0 to 60% wt fat thereof and 3) mixing the at least one cooked ingredient (I) with the at least one fruit, vegetable or cereal product before, during or after the fruit, vegetable or cereal product is mixed with the dressing and wherein the cooking paste and the dressing are provided as a kit for preparing a salad.

The method allows for the quick and convenient preparation of salads which are nutritious and which have a controlled content of fat.

According to a third aspect of the invention, there is provided a salad comprising at least one ingredient (I) which is cooked and at least one fruit, vegetable or cereal product and which is prepared using the kit of the first aspect of the invention and/or by the process of the second aspect of the invention.

The term ‘fat’ as used herein includes both solid and liquid fats (oils).

The term ‘fish’ as used herein includes shellfish.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

### DETAILED DESCRIPTION OF THE INVENTION

a) Flavoured Cooking Paste

The flavoured cooking paste is used to cook the ingredient (I) which is present as a cooked ingredient in the salad and it comprises from 40 to 80% wt fat, preferably 45-75% wt, most preferably 50-75% wt, based on the weight of the cooking paste.

The cooking paste is used to flavour ingredient (I) by at least partially cooking the ingredient in the product. Any suitable cooking method may be employed including frying, baking, grilling, steaming and micro-waving. Boiling is not preferred because the product tends to become removed from the ingredient (I) and does not then flavour it as well as in the other methods. The cooking paste can also be used to marinade the ingredient (I) which is later cooked with the product still in contact with it.

The fat may be any edible fat such as animal derived fats, dairy derived fats (such as butter) or those of vegetable origin, especially triglyceride oils of vegetable origin.

The following vegetable derived oils have been found to be especially suitable; olive, rapeseed, sunflower, corn, maize, soy bean, palm, sesame, coconut, linola, canola, cottonseed, safflower, linseed oil, arachidic oil and mixtures thereof. Mixed vegetable oil is also suitable. The fat may be hydrogenated or non-hydrogenated or a mixture thereof. The fat may comprise only non-crystallised fat, or, a blend of crystallised and non-crystallised fat may be used. For the purpose of the present invention, the fat may comprise purely liquid fat or alternatively liquid fats comprising some crystallised fat content.

Preferably the cooking paste comprises a fat blend, which preferably comprises:

(i) 90-99.8 wt % of liquid oil, and

(ii) 10-0.2 wt % of a hard fat component, that has the ability to form a crystal network in the end product, preferably being hardened high erucic rapeseed oil.

The liquid oil, may be applied in amounts of 90-99.8 wt % in these fat blends and can be selected from the group, consisting of: sunflower oil, high oleic sunflower oil, rapeseed oil, safflower oil, high oleic safflower oil, soyabean oil, coconut oil, maize oil, cotton seed oil, arachidic oil, olein-fractions of natural oils, such as palm oil olein, MCT-oils.

The oil preferably displays a solid fat content (NMR-pulse, not-stab.) of less than 10% at 20□ C. Preferably the amount of liquid oil is 93-99 wt %, most preferably 95-98 wt % in the fat blend.

The hard fat component of these blends preferably has the ability to form a crystal network in our compositions. Examples of suitable fats are hardened rapeseed oil, hardened sunflower seed oil, hardened soybean oil, hardened palm oil, hardened cottonseed oil or mixtures thereof. The best results were obtained, by using hard fats, having an I.V. <10, preferably containing >40 wt % of C₂₀₊-saturated fatty acids. A most preferred hard fat is fully hardened, high erucic rapeseed oil (Rp-70).

The cooking paste comprises flavouring agents, typically in amounts of from 0.5 to 45% wt, preferably 5 to 30% wt, most preferably 10 to 25% wt. The types and amounts of flavourings will depend upon the final flavour and flavour intensity required. The flavours may be natural or artificial and may be added as pastes, powders, liquids or solids etc. Typical flavourings include honey, herbs, nuts, seeds, vegetables, spices including mustard, fruit, meat, poultry or fish flavourings, alcoholic flavours such as wine or brandy etc, dairy products such as cheese or yoghurt. Herbs are defined in The Illustrated Herbal Handbook by J. de Ba□racli Levy, Faber and Faber Ltd., Londen, chapter 3. Spices are defined in “The Book of Spices”, Livingstone Publ. Comp. 1969, p. 3.

Flavour enhancers, such as monosodium glutamate, may be used in the cooking paste, typically in amounts of up to 1% wt.

The cooking paste may comprise water in amounts of up to 10% wt, preferably 0 to 5% wt water, most preferably 0 to 2% wt. The lower amounts of water are preferred as they give better microbiological stability to the product. It is especially preferred that the cooking paste is prepared without added water, so that any water content is present from the ingredients themselves. It is also preferred that at least one of the cooking paste ingredients is dried before being used to produce the cooking paste.

The cooking paste may comprise one or more thickeners. Any conventional thickener such as natural or modified starches including hydrolysed starches, celluloses, alginates and natural or modified gums including (iota)carrageenan, guar gum, locust bean, xanthan gum or gelatin may be used. Typical amounts for the thickener are in the range of from 0.05 to 2 or 5% wt, more preferably 0.1 to 1.5% wt, most preferably 0.1 to 1% wt thereof.

An emulsifier may be included in the cooking paste and any suitable edible emulsifier may be included. It is preferred that the emulsifier comprises an egg yolk derived emulsifier, most especially one selected from egg yolk, stabilized egg yolk, fortified stabilized egg mix, dried egg yolk, salted egg yolk, enzymatically treated egg yolk such as (spray) dried egg-yolk powder stabilised using an enzyme having phospholipase A2 activity and whole eggs. Blends of any of the preceding types with egg white may also be used.

The cooking paste may comprise an amount of from about 0.5 or 1 to 8% wt of emulsifier, more preferably from 2 to 7% wt, most preferably 3 to 6% wt for egg derived emulsifiers. For non-egg derived emulsifiers such as lecithin and monoglycerides, the products preferably comprise an amount of from about 0.05 or 2% wt non-egg derived, more preferably from 0.1 to 1% wt, most preferably 0.2 to 0.8% w.

The cooking paste may comprise milk-proteins, which can be added as milk, skimmed milk powder or as full milk powder. The amount used is preferably in the range from 1-8 wt %, in particular from 2-6 wt %.

The cooking paste may be mixed up with hot water, hot milk, stock, or other hot aqueous liquid, i.e. having a temperature of >80^{˜}C, preferably 85-99^{˜}C, in particular 90-95^{˜}C, prior to cooking ingredient (I) without having lumping or caking problems. The amount of water, milk, or aqueous liquid used depends on the thickness and taste requirements of the user. Typical dilution rates are 1 part of the cooking paste to between 3 to 8 parts, preferably 4-6 parts, of aqueous liquid. After the mixing of the ingredients the composition should ideally be kept at the high temperature for some minutes for cooking purposes and to ensure thickness.

Alternatively, the cooking paste may be added to a cold aqueous liquid (e.g. water, wine, milk, stock, etc.), whereafter heat may be suitably applied to achieve a thickening effect.

The Dressing

The dressing is used for contacting with the at least one fruit, vegetable or cereal product, and comprises from 0 to 60% wt fat based on the weight of the dressing. It is also preferred that the dressing comprises 10-40% wt fat, more preferably 15 to 35% wt fat. The fats disclosed hereinabove for the cooking paste may also be used for the dressing.

Typically the dressing is contacted with the at least one fruit, vegetable or cereal product by mixing with, or being poured over the latter. This may happen either before, after or during when the ingredient which is cooked in the cooking paste is added.

It is preferred that the dressing is an emulsion, especially, an oil-in-water emulsion.

The dressing preferably comprises flavouring agents, typically in amounts of from 0.1 to 20% wt, preferably 0.5 to 15% wt, most preferably 1 to 10% wt. The types and amounts of flavourings will depend upon the final flavour and flavour intensity required and the same types as disclosed above for the cooking paste may be used.

Flavour enhancers, such as monosodium glutamate, may be used in the dressing, typically in amounts of up to 1% wt.

The dressing preferably comprises water, especially in an amount of from 5 or 10 to 65% wt water based on the weight thereof, preferably 15 to 50% wt, most preferably 20 to 45% wt.

The dressing may be, for example, a liquid, a gel or as a spoonable product (such as a low fat mayonnaise) as desired.

The dressing may comprise one or more thickeners and the same types may be used as disclosed for the cooking paste. Typical amounts for the thickener are in the range of from 0.05 to 3% wt, more preferably 0.1 to 2% wt, most preferably 0.1 to 1.5% wt thereof.

An emulsifier is typically included in the dressing to aid the formation and/or aid the stability thereof. Any suitable edible emulsifier may be included and those disclosed above for the cooking paste are suitable in the same amounts.

The dressing may comprise the same types and amounts of milk-proteins as described hereinabove for the cooking paste.

The dressings preferably have a pH at 20° C. in the range of from 3.0 to 5.0. The exact pH will depend upon the flavour desired and whether preservatives are also present therein. At the more acidic pHs, added preservatives are often not necessary as the low pH inhibits the growth of pathogens and/or spoilage yeasts or moulds.

In an especially preferred embodiment, the dressing has a pH at 20° C. in the range of from 3.2 to 4.5, more preferably of from 3.4 to 4.0.

The dressing preferably has an undissociated (acetic) acid content in the aqueous phase of the emulsion of up to 3% wt based on the weight of the aqueous phase, preferably of from 0.1 to 2% wt, more preferably of from 0.1 to 1.5% wt, most preferably of from 0.5 to 1.5% wt.

The acid content may be provided by the inclusion of any edible acid in a suitable amount to achieve the desired pH range. These acids are present in the aqueous phase of the emulsion and suitable edible acids include acetic acid, citric acid, edible hydrochloric acid, edible phosphoric acid, malic acid, tartaric acid, gluconic acid and lactic acid amongst others.

The dressing may contain sweetening agents such as sugar, sugar solutions or artificial sweeteners in any suitable amounts.

Other Optional Ingredients

The cooking paste and the dressing may individually comprise one or more additional optional ingredients selected from preservatives such as scorbic acid or salts thereof, sugar, stabilisers, colourings etc. The amount of these optional ingredients will depend upon the type of ingredient included and the desired taste but will typically be in the range of from 0.05 to 5% by weight per type of ingredient. The cooking paste may also optionally comprise edible acids in amounts of up to 5% wt.

An edible salt is preferably included in either the cooking paste or the dressing, preferably both, and can be derived from inorganic or organic acids or bases. The most preferred edible salt is NaCl. The preferred amount of the edible salt is in the range of from 2-7 wt %.

Extracts from meat, fish, fruit or vegetables may also be used in either the cooking paste or the dressing. Typically amounts will be in the range of from 1 to 30% wt based on the total weight of the product, preferably 2 to 28% wt.

The weight ratio of the fat in the cooking paste to the fat in the dressing, based on the total weight of the cooking paste plus dressing, is preferably in the range of from 80:1 to 1:1.5, most preferably 50:1 to 1:1, more preferably 10:1 to 1:1, such as 5:1 to 1:1.

Process to Prepare the Cooking Paste/the Dressing

The cooking paste and the dressing may be prepared by any suitable process, using any suitable apparatus, for producing such products. The ingredients may, for example, be combined and mixed until the required product viscosity/homogeneity is formed. Alternatively, the ingredients may be heated and homogenised followed by cooling e.g. under shear.

A pasteurization or sterilisation step (including a U.H.T. step) may be carried out at any time during the process; either on the final product or at any time during the process. Normal conditions for pasteurisation treatments may be used e.g. treatment at 80-90° C. for a period of from 1 to 10 minutes.

A suitable methods to prepare the cooking paste, including when it comprises a thickener and a liquid oil are disclosed in EP-A-977 490.

Kit

The kit may be prepared according to any suitable method. For example the kit may be sold as comprising a container of the cooking paste and a container of the dressing packaged together, for example by shrink wrapping or by otherwise being provided together in a package. The cooking paste and the dressing may also form part of the same container which has been separated into sections.

The amounts of the cooking paste and the dressing included in the kit will vary upon the number of portions of salad for which the kit is intended and also upon the flavours of the cooking sauce and dressing. For example a very strongly flavoured cooking paste or dressing may be provided in smaller quantities in the kit than a very mildly flavoured one. Typically, for a salad for two people, 20-200 g, preferably 20-150 g, most preferably 40-80 g, such as 55 g, of the cooking paste and 50-500 g, preferably 80-250 g, most preferably 100-200 g, such as 150 g, of the dressing will be included in the kit. This kit would typically be used with 100 to 400 g, preferably 150-300 g, such as 200 g in total of fruit, vegetable or cereal product and 100 to 400 g, preferably 200-350 g, such as 300 g in total of the ingredient (I) which is cooked in the cooking paste.

The tastes of the cooking paste and the dressing present together in the kit can be chosen to be contrasting or complementary, for example tomatoes and herbs, salsa and lime etc.

It is preferred that the total fat content of the cooking paste and the dressing combined is in the range of from 5 to 60 or 70% wt, more preferably 15 to 50% wt, most preferably 20 to 40% wt.

The weight ratio of the amount of cooking paste in the kit to the amount of dressing in the kit is preferably in the range of from 1:10 to 5:1, more preferably 1:5 to 2:1, most preferably 1:5 to 1:1.

Salad Ingredients

The ingredient (I) which is cooked in the cooking paste may be any food ingredient which it is desired to cook and add to a salad. It is especially preferred that the ingredient is a protein-rich source such as chicken, egg, meat, fish, a vegetable-derived protein source e.g. tofu or beans, or, other foods which are cooked such as cooked fruit or vegetables. Bread may also be cooked in the cooking paste to provide a flavoured bread cooked ingredient.

The salad also comprises at least one fruit, vegetable or cereal product which may be cooked or uncooked. However, if it is cooked (such as rice or pasta) then there must be at least one other ingredient, or portion of the same ingredient, which is cooked in the cooking paste. The fruit can be any fruit and the vegetable can be any vegetable including salad leaves. The cereal may be any cereal such as couscous, rice, pasta, croutons etc.

The salad can also include other additional ingredients such as cheese, raw meat, fish and poultry and also cooked meat, fish and poultry which have not been cooked in the cooking paste.

Making the Salad

Methods of making the salad are given hereinabove according to the second aspect of the invention. Any suitable method can be used to produce the salad as long as ingredient (I) is cooked in the cooking paste and the at least one fruit, vegetable or cereal product is contacted with the dressing.

The invention is further exemplified by the following examples, which are to be understood as to be non-limiting. Further examples within the scope of the invention will be apparent to the person skilled in the art.

### EXAMPLES

### Example 1

A cooking paste and a pourable oil-in-water emulsion salad dressing were prepared according to the following formulations using the methods given below:

TABLE 1
Tomato, garlic and herb cooking paste

| Ingredient | % by weight |
|---|---|
| Vegetable oil and hydrogenated | 70.44 |
| vegetable oil | |
| DATA-ester monoglyceride | 0.39 |
| emulsifier | |
| Egg yolk powder | 3.91 |
| Sugar | 3.52 |
| Salt | 2.35 |
| Monosodium glutamate | 0.27 |
| Flavouring mix: including tomato | 19.12 |
| powder, garlic powder, black | |
| pepper, paprika and mustard flour | |
| Total | 100% wt |

The cooking paste was prepared by combining all of the ingredients together in a food mixer at room temperature and mixing until a smooth homogenous paste was obtained. The cooking paste was then put in 55 gram portions into suitable jars.

TABLE 2
Cheese and herb salad dressing

| Ingredient | % wt |
|---|---|
| Water | 42.32 |
| Sucrose/glucose syrup | 11.98 |
| Vinegar 12% | 6.23 |
| Xanthan gum | 0.26 |
| Egg yolk powder | 1.56 |
| Starch | 1.04 |
| Salt | 2.59 |
| Potassium sorbate | 0.16 |
| Vegetable oil | 28.22 |
| Flavouring mix: including | 5.64 |
| Parmesan cheese and basil | |

The oil-in-water salad dressing was prepared by combining all of the ingredients together at room temperature, emulsifying in a high speed mixer, and then putting the salad dressing in 150 gram portions into suitable jars.

The cooking paste and the salad dressing jars were secured together using a full-body sleeve to produce a kit for preparing salads, the kit comprising 55 g of the cooking paste and 150 grams of the pourable salad dressing. To make a warm salad 300 g chicken was cooked (stir fried) in 55 g of the cooking paste. To this was added 200 g of salad leaves and 150 grams of the salad dressing and the mixture stirred to produce the salad meal.

The salad had a good taste and was quick and convenient to prepare. It had an acceptable level of oil and did not feel or taste too oily.

1. A kit for preparing salads comprising at least one ingredient (I) which is cooked and at least one fruit, vegetable or cereal product, wherein the kit comprises;
a) a flavoured cooking paste for cooking ingredient (I), which cooking paste comprises from 40 to 80% wt fat, based on the weight thereof, and
b) dressing for contacting with the at least one fruit, vegetable or cereal product, which dressing comprises from 0 to 60% wt fat based on the weight thereof.

2. The kit of claim 1, wherein the dressing is an emulsion.

3. The kit of claim 1, wherein the emulsion is an oil-in-water emulsion.

4. The kit of claim 1, wherein the dressing comprises from 10 to 40% wt fat.

5. The kit of claim 1, wherein the dressing is a salad dressing.

6. The kit of claim 1, wherein the cooking paste comprises from 45 to 75% wt fat.

7. The kit of claim 1, wherein the weight ratio of fat in the cooking paste to fat in the dressing is in the range of from 10:1 to 1:1.

8. The kit of claim 1, wherein the total fat content of the cooking paste and the dressing combined is in the range of from 5 to 60% wt.

9. The kit of claim 1, wherein the at least one cooked ingredient (I) is chicken, egg, meat, fish, a vegetable-derived protein source, cooked fruit, cooked vegetables or cooked bread.

10. The kit of claim 1, wherein the at least one fruit, vegetable or cereal product comprises salad leaves, a salad vegetable, pasta, rice, cous cous or a wheat based product.

11. The kit of claim 1, wherein the weight ratio of the cooking paste to dressing is in the range of from 1:5 to 2:1.

12. A process for preparing a salad comprising at least one ingredient which is cooked and at least one fruit, vegetable or cereal product, the process comprising the steps of 1) cooking the at least one ingredient in a flavoured cooking paste comprising from 40 to 80% wt fat thereof, to produce at least one cooked ingredient (I), and 2) contacting the at least one fruit, vegetable or cereal product with a dressing comprising from 0 to 60% wt fat thereof and 3) mixing the at least one cooked ingredient (I) with the at least one fruit, vegetable or cereal product before, during or after the fruit, vegetable or cereal product is mixed with the dressing and wherein the cooking paste and the dressing are provided as a kit for preparing a salad.

13. A salad comprising at least one ingredient (I) which is cooked and at least one fruit, vegetable or cereal product and which is prepared using the kit of claim 1 and/or by the process of claim 12.
